(19) United States
(12) Patent Application Publication
(10) Pub. No.: US 2005/0236594 A1
(43) Pub. Date: Oct. 27, 2005

(54) Wireless remotely-operable utility flow-control valve and method

(76) Inventors: David J. Lilly, Atlanta, GA (US); Marcus J. Lilly, Atlanta, GA (US)

Correspondence Address: MCKENNA LONG & ALDRIDGE LLP, 1900 K STREET, NW, WASHINGTON, DC, 20006, US

(21) Appl. No.: 10/830,311

(22) Filed: Apr. 23, 2004

(51) Int. Cl. F16K 31/02

(52) U.S. Cl. 251/129.03; 251/129.04; 137/557

(57) ABSTRACT

A wireless remotely controlled valve system includes a wireless switch with a transmitter, a valve actuator controlled by the wireless switch, and a valve attached to and controlled by the actuator, wherein the valve is a main supply shutoff for a residential utility supply system, wherein when the wireless switch is actuated, the transmitter transmits a signal that activates the actuator to toggle the valve between open and closed states to turn on and off the utility supply system.

### BACKGROUND OF THE INVENTION

1. Field of the Invention

The present invention relates to the use of a wireless remotely operable control valve that may be fitted to a standard quarter-turn ball valve for use in residential and commercial flow-oriented utility supply systems, for example, gas and water supply systems. The present invention enables the easy closing or opening of the valve by a novice or expert operator, who may be located away from the control valve. The invention enables the operator to quickly and easily remotely actuate the valve without requiring any specialized knowledge, tools or training.

2. Discussion of the Related Art

The present invention is directed to reducing the damage resulting from residential water system leaks, gas system leaks and other utility emergency applications. Facility occupants, including homeowners, tenants, commercial business owners, as well as tenants in all types of residential or commercial facilities (single-family homes, apartments, condominiums, rental properties, businesses, etc.), often are unaware of the location of that facility's main water, gas and other utility shutoff valves, and are unfamiliar with how these valves are operated. This lack of familiarity and knowledge often results in increased damage and repair/renovation expense of the facility if a leak or break occurs in the pipes, valves, fittings or fixtures that make up these utility supply systems. For example, during the time required to locate the main water shutoff valve and to operate the valve during a high-stress situation, thousands of dollars of damage may result, and costly repairs are needed. These situations also may lead to unsafe environments, which may cause severe injury or death by explosions, flooding or electrical shock.

Therefore, there remains a need for a remotely operable valve that occupants can actuate using a simple to operate remote switch located at a convenient location inside the facility (as opposed to a basement, crawl space or outdoors) to immediately shut a down water, gas or other utility supply to the facility. Further damage may be prevented, and actual damage to the facility may be substantially reduced due to the ability of the occupant to quickly shut off the utility supply system. As a benefit, insurance costs related to property and casualty insurance claims and rising insurance premiums may be substantially reduced as a result of this invention.

### SUMMARY OF THE INVENTION

Accordingly, the present invention is directed to a wireless remotely-operable utility flow-control valve and method that substantially obviates one or more of the problems due to limitations and disadvantages of the related art.

An advantage of the present invention is to provide shut down of a utility system supply quickly and efficiently from a safe, remote location.

Another advantage of the present invention is to provide the capability to remotely operate the valve using a wireless battery-powered switch. This switch can be placed conveniently and easily by the facility owner anywhere throughout the home or business to enable fast and easy access to the switch. The wireless nature of the switch enables location without regard to installation of wiring behind walls or between floors.

These aspects and embodiments, as well as other aspects and embodiments of the present invention are more clearly described in the specification, figures and claims.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a wireless remotely controlled valve system includes a wireless switch with a transmitter, a valve actuator and integrated receiver, which is controlled by the wireless switch, and a valve attached to and controlled by the actuator, wherein the valve is a main supply shutoff for a residential utility supply system, wherein when the wireless switch is actuated, the transmitter transmits a signal that activates the actuator to toggle the valve between open and closed states to turn on and off the utility supply system.

In another aspect of the present invention, a method of remotely turning off a residential utility supply system, includes actuating a wireless switch, transmitting a wireless signal when the switch is actuated, receiving the wireless signal, actuating a valve attached to the residential utility supply system in response to receiving the wireless signal, wherein actuating the valve includes opening and closing the valve.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a block diagram illustrating the functional components of an embodiment of the remotely operated valve assembly;

FIG. 2 illustrates an embodiment of the switch according to the present invention;

FIG. 3 illustrates the switch with the housing removed; and

FIG. 4 illustrates a valve actuator according to the present invention.

### DETAILED DESCRIPTION OF THE ILLUSTRATED EMBODIMENTS

Reference will now be made in detail to an embodiment of the present invention, example of which is illustrated in the accompanying drawings.

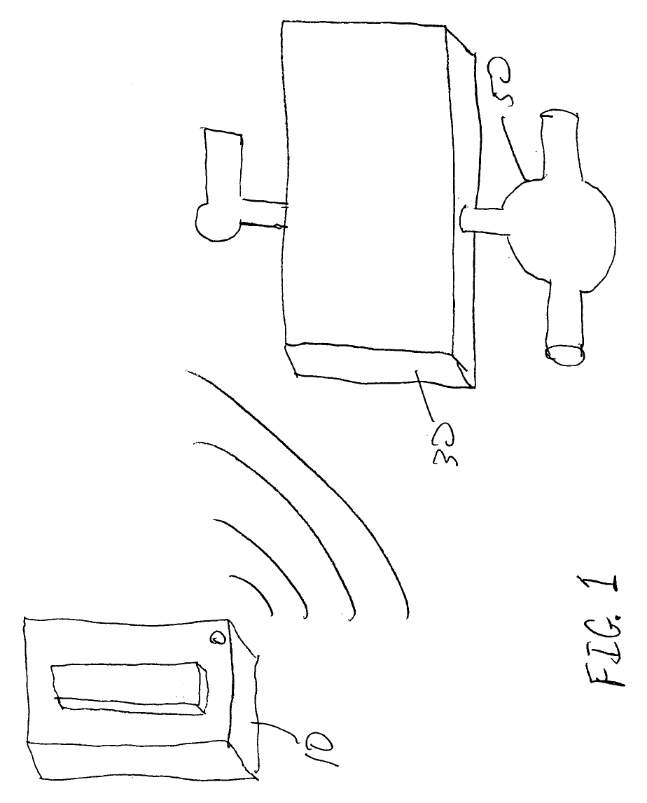

FIG. 1 is a block diagram illustrating the functional components of an embodiment of the remotely operated valve assembly. The switch 10 transmits a wireless control signal when actuated to the remotely operable valve actuator 30 that then actuates a flow-control valve 50 that is compatible with the facility's utility supply system (water, gas, etc.). The control signal sent to valve actuator 30 may contain an instruction to open or to close the valve 50 to enable to flow of water/gas (open) or to stop the flow of water/gas (closed). The control signal may also just cause the valve actuator to toggle to the other position, that is open to closed or closed to open.

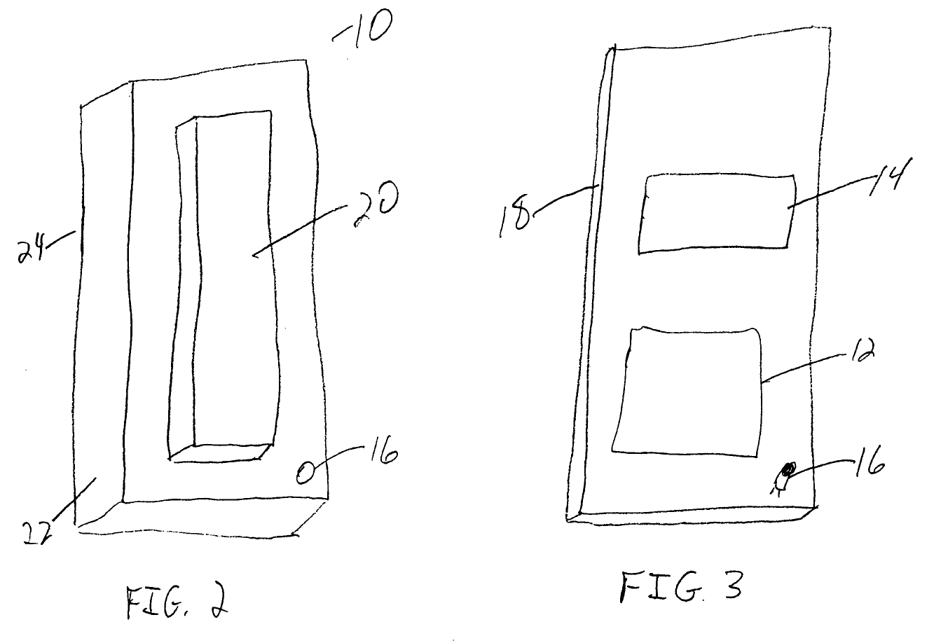

FIG. 2 illustrates an embodiment of the switch 10 according to the present invention. The switch may include a switch housing 22, a switch button 20, a power status lamp 16, and an adhesive backing 24. The switch housing 22 accommodates the switch button 20 and the power status lamp 16 so that it is visible to a user. The switch button 20 may include a switch mechanism that closes when pressed. The switch button 20 also may be a toggle type switch as well. Further, the switch housing 22 allows the power status lamp 16 to be viewed. The switch 10 may also have an internal light that allows the switch 10 to be more easily seen in the dark. The adhesive backing 24 allows for the switch to be easily mounted in a convenient and easy to reach location. The switch 10 may also be mounted using any other convenient method.

FIG. 3 illustrates the switch 10 with the housing 22 removed. The switch 10 may further include a base 18, a switch circuit board 12, and a power supply 14. The switch circuit board 12 includes a wireless transmitter that transmits a wireless control signal and that receives power from the power supply 14. The wireless transmitter transmits a distance likely to be encountered in homes or multi-dwelling units. Further, the transmitter may also transmit a signal capable of penetrating the structure of a typical dwelling unit. The switch circuit board 12 may also be an application specific integrated circuit (ASIC). The power supply 14 may be a battery, and any type of battery may be used. Currently solid-state batteries may be used. Solid-state batteries have been developed to provide a reliable long-term energy supply that maintains the ability to supply energy after a long period of nonuse. Also, power may be supplied using a standard AC power supply. Further, if AC power is used, a backup battery supply may also be included to provide power in case of power failure. A power status lamp 16 enables the visual monitoring the status of the battery's charge. When the lamp is out, the battery must be replaced for the wireless transmitter to properly transmit a control signal to the remotely located valve actuator 30. Further the switch may include markings or an indicator to show whether the utility flow is currently on or off.

Because the switch is wireless, the switch may be placed anywhere that is convenient with out the worry of running wires to the switch. If the switch is battery powered, this further frees the placement of the switch, as proximity to an AC power source is not an issue.

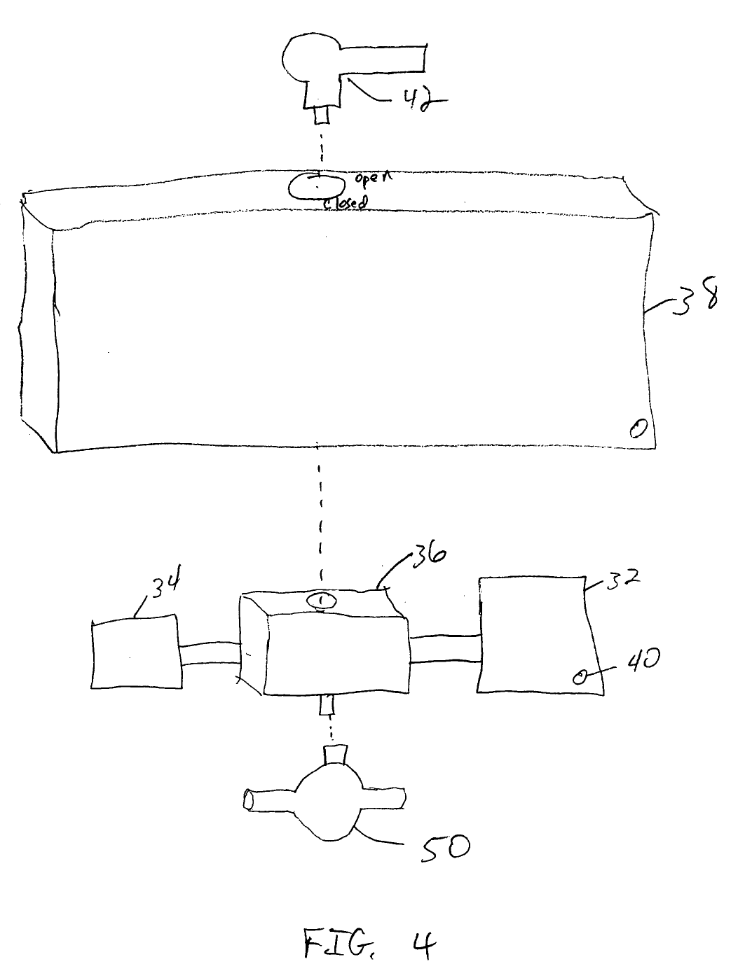

FIG. 4 illustrates a valve actuator according to the present invention. The remotely controllable valve actuator 30 may include an actuator circuit board 32, a power source 34, a motor 36, a housing 38, a valve status indicator 40 and a manual override valve handle 42. The actuator circuit board 32 includes a wireless receiver that receives the wireless control signal transmitted by the wireless switch 10. The actuator circuit board 32 may include an ASIC implementing the wireless receiver. The power source 34 may be a battery such as described above. The power source powers the wireless receiver and the motor 36. Also, power may be supplied using a standard AC power supply. Further, if AC power is used, a backup battery supply may also be included to provide power in case of power failure. The motor 36 allows for the rapid actuation of the valve 50. The actuator circuit board 32, the power source 34, and motor 36 may reside in a housing 38. The housing protects the housed elements from the external environment. In one embodiment of the present invention the housing 38 is NEMA 4X (National Electrical Manufacturing Association) compliant. The NEMA 4X standard defines requirements for resistance to various indoor and outdoor environments. The valve status indicator 40 may be a lamp or LED that indicates the current status of the valve such as open or closed. The valve status indicator 40 may be attached to the circuit board 32. The manual override valve handle 42 enables an operator who is in the proximity of the valve actuator 30 to rotate the valve 50 to an open or closed state without actuating the wireless transmitter/receiver. This enables the operator to manually open or close the valve 50 for service purposes, or as a failsafe in the case of complete failure of the valve actuator 30. Further, the valve actuator 50 may include a battery status indicator similar to that described for the switch 10.

The valve 50 may be a standard plumbing or gas fitting that requires a quarter-turn to seat the valve into the closed position from open, or into the open position from closed. Such a valve is widely available and low cost. Other valves may be used as well depending upon the application's requirements.

In another embodiment of the present invention the control signal is encoded for security purposes, for example using encryption, and also to allow for operation without interference from nearby wireless shut off systems or to prevent the inadvertent actuation of a nearby system due to stray signals from unrelated devices. The system may allow the operator to select the encoding for the system, or the encoding may be preset at the time of manufacture. When the signal is received, it may then be decoded, for example using decryption. In order to encode and decode the wireless control signal, the switch 10 and valve actuator 30 may include pin switches, dip switches, signal scrambling devices, signal encryption/decryption technology or other similar devices. These devices may operate with or be incorporated into the wireless transmitter or the wireless receiver.

In another embodiment of the present invention, multiple valves may be operated from a single switch. These valves may all control the flow of the same or different types of utility supplies, for example a group of water lines or a water and gas line. In another embodiment, multiple switches may operate multiple, discrete valves. The switches may be on a single panel or co-located in some other way. In this situation, each switch may use a unique encoding in order to only actuate the desired valve 50. These embodiments may be implemented in multi-unit dwelling where each unit has individual utility supplies. A building supervisor could turn off the utility supply to one unit or all units with the above described embodiments. In such multi-unit dwellings, each unit may have its own switch 10 accessible to the occupant. The building supervisor would also have access to another switch 10 that also actuates the supply to the unit. Further, there may be a single building switch that may be used to turn all of the supplies off to each unit in addition to the individual switches in each unit. This would require the use of individual codes for each switch, and then a master code that can actuate all of the switches. Therefore, each valve actuator wireless receiver could be actuated by two different codes: a unique individual code and a building master code.

The present invention, as described above, enables a variety of tenants, homeowners facility managers and owners to rapidly respond to utility emergencies with a simple to install and simple to operate system. Two example applications of the present invention include a conveniently accessible safety switch and a handicapped accessible safety switch. When used as a safety switch, the system may be utilized to provide safety and rapid response during a utility emergency for any tenants, homeowners or occupants of a particular facility. This allows for an expedient response to a utility system emergency or leak, by enabling an occupant to quickly access and shut down the facility's various utility supply systems. The time saved by not having to locate, and in some instances experiment with the operation of, unfamiliar or unmarked utility shut-off valves, can save lives, reduce damages, minimize repairs and reduce insurance claims, costs and premiums related to property and casualty insurance for a facility. When used as a handicapped accessible safety switch, the system can be utilized to provide safety and rapid response during utility emergency for handicapped, mentally incompetent or physically disabled tenants, homeowners or occupants of a particular facility. This can provide additional security and safety for handicapped tenants, by enabling them to rapidly shut down a broken system without reliance on some outside party like a family member, neighbor, or utility system repair person. The switch in this application may be larger and easier to activate for those with handicaps.

The present invention allows for greater facility safety and security from damage without requiring: (a) knowledge of where the shutoff valves for various home utilities are located; (b) specialized knowledge of how to operate and shutoff the primary valves for these home utility systems; (c) reliance on third-parties (emergency personnel, repair technician, neighbor, other occupant, etc.) to shutdown these systems when a utility emergency occurs; and/or (d) specialized access corridors to be constructed in areas like basements, crawl-spaces and utility access tunnels to accommodate handicapped users as dictated by the Americans with Disabilities Act (ADA). Also, once installed, the system can be actuated/operated by any novice occupant/user (even a child can be instructed to safely and efficiently operate the switch if there is a water or other utility system leak in the facility).

Another advantage of the present invention is the ability to actuate the valve 50 in a way that does not create an electric arc that may ignite explosive or flammable fumes or gasses, which have accumulated in the vicinity of the switch 10 or the remote valve actuator 30. This further increases the safety of the facility and occupants of the facility, in addition to emergency personnel, by reducing the risk of explosions due to sparks or electric arcs that can be generated by AC power systems (like turning on lights to locate a shut-off valve).

As described above the present invention may use a solid-state power supply. The solid-state power supply is a type of battery that lies dormant until its first use, but once used reliably generates power for a number of years before requiring replacement. This type of power supply will reduce the tendency for consumers to neglect the consistent, periodic replacement of battery systems in both the remote switch, and the valve actuator assembly to ensure a fresh and reliable power supply is available in case of an emergency. Also, these advanced power supplies may reduce the risk of corrosion or rust that often occurs if batteries rupture after long periods of storage or dormancy.

Another feature of the present invention is the ability for the electrical circuitry and components of the system to remain in a “dormant” state, with only a small amount of power being drawn from the power supply of the switch. The system has the capability to “wake up” once the switch is actuated, and send a signal to the receiver and valve. Similarly, the valve and receiver remain in a “dormant” state until a signal is received from the switch (or remote sensor) whereby the valve circuitry “wakes up” and performs the actuation of the valve. This “dormant” state enables the entire system to minimize the usage of power during the potentially long periods of time spent waiting for an actuation event, but have substantial power in reserve for responding to the actuation event.

The present invention may generate an audible alert signal at a specified interval when the battery gets low. This provides an indication that the battery needs to be changed. This can be implemented in either the switch 10 or the valve actuator 50 or both. Further, the switch 10 or the valve actuator 50 may include a battery test capability, where, for example, the user presses a button to verify that the battery is still operable.

Another embodiment of the present invention may include remote sensing units that may be placed in any location where unwanted water may be. The presence of this water may indicate an unexpected breach in the water system. The sensor may send a signal to the valve system to turn off the water system to prevent further water leakage.

In yet another embodiment of the present invention, electrical power may be shut off. In this embodiment, an electrical switch or breaker is used instead of a valve 50. The actuator 30 acts to shut off the electrical power by actuating the electrical switch or breaker.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A wireless remotely controlled valve system comprising:
a wireless switch with a transmitter;
a valve actuator controlled by the wireless switch; and
a valve attached to and controlled by the actuator, wherein the valve is a main supply shutoff for a residential utility supply system;
wherein when the wireless switch is actuated, the transmitter transmits a signal that activates the actuator to toggle the valve between open and closed states to turn on and off the utility supply system.

2. The system of claim 1, wherein the wireless controllable switch is battery powered.

3. The system of claim 2, wherein the battery is a solid-state battery system.

4. The system of claim 2, wherein the wireless controllable switch is also powered via a standard alternating current power source.

5. The system of claim 1, further comprising a flow indicator.

6. The system of claim 1, wherein the automatic valve actuator is battery powered.

7. The system of claim 6, wherein the battery is a solid-state battery system.

8. The system of claim 1, wherein the utility supply system is one of a water supply system and a gas supply system.

9. The system of claim 1, where in the wireless controllable produces an encoded wireless control signal.

10. The system of claim 9, wherein the actuator decodes the encoded wireless control signal.

11. The system of claim 1, wherein the automatic valve actuator includes:
a wireless control signal receiver;
a battery power supply; and
a motor that actuates the valve;
wherein actuator opens or closes the valve when a control signal is received from the wireless switch.

12. The system of claim 11, wherein the automatic valve actuator includes a status indicator showing the physical status of the valve,

13. The system of claim 11, wherein the automatic valve actuator includes a NEMA compliant housing.

14. The system of claim 1, further comprising a manual override valve handle to open or close the valve manually.

15. The system of claim 1, further comprising a remote water sensor that detects unwanted water and transmits a wireless signal to actuate the valve.

16. A method of remotely turning off a residential utility supply system, comprising:
actuating a wireless switch;
transmitting a wireless signal when the switch is actuated;
receiving the wireless signal;
actuating a valve attached to the residential utility supply system in response to receiving the wireless signal, wherein actuating the valve includes opening and closing the valve.

17. The method of claim 17, further comprising encoding the transmitted wireless signal and decoding the received wireless signal.

18. The method of claim 17, further comprising setting a unique code to uniquely encode and decode the wireless signal.

19. The method of claim 16, further comprising detecting flow in the residential utility supply system.

20. The method of claim 19, further comprising displaying the detected flow information.

21. The method of claim 17, further comprising producing an audible alarm indicating that battery power in one of the wireless switch or the actuating ball valve is low.

22. The method of claim 19, further comprising remotely sensing unwanted water and automatically transmitting a wireless signal to actuate the valve.
